(19) United States
(12) Patent Application Publication
(10) Pub. No.: US 2009/0109578 A1
(43) Pub. Date: Apr. 30, 2009

(54) VERTICAL MAGNETIC RECORDING HEAD AND MAGNETIC RECORDING APPARATUS USING THE SAME

(75) Inventor: Kiyoshi Nishikawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/179,280

(22) Filed: Jul. 24, 2008

(30) Foreign Application Priority Data
Oct. 24, 2007 (JP) 2007-276650

(51) Int. Cl. G11B 5/33

(52) U.S. Cl. 360/319; 360/313

(57) ABSTRACT

The invention relates to a vertical magnetic recording head that records information on a recording medium, such as a magnetic disk, and a magnetic recording apparatus using the same. An object of the invention is to provide a vertical magnetic recording head capable of preventing the leakage of a magnetic field without deteriorating a recording performance and a magnetic recording apparatus using the same. A vertical recording magnetic head is mounted on a slider having a medium facing surface, and includes a main magnetic pole that includes a leading end exposed from the medium facing surface; and side shields that are separated from the side surface of the leading end by a first distance and are retreated from the medium facing surface by a second distance.

### BACKGROUND

1. Field

The present invention relates to a vertical magnetic recording head that records information on a recording medium, such as a magnetic disk, and a magnetic recording apparatus using the same.

2. Description of the Related Art

In recent years, magnetic recording apparatuses have been known which include magnetic recording heads that read or write information from or on recording media, such as magnetic disks. In this type of magnetic recording apparatus, in order to increase information recording capacity per unit area in a recording medium, that is, recording density, it is necessary to increase the density of the recording medium in both a track width direction and a bit length direction thereof. However, in an in-plane recording method that has been commonly used, when a recorded bit length is shortened, it is difficult to increase in-plane recording density due to the thermal fluctuation of the recording medium. In order to solve these problem, a vertical recording type magnetic recording head, that is, a vertical magnetic recording head has been proposed which magnetizes a recording medium in a direction vertical to a recording surface to improve recording density.

In a vertical recording type magnetic recording apparatus, in a reproduction mode, it is possible to use, for example, a giant magnetic magnetoresistive head (GMR) or a tunnel giant magnetic magnetoresistive head (TMR) having a high reproduced output. Meanwhile, in a recording mode, a single magnetic pole head including a main magnetic pole and an auxiliary magnetic pole is used as a vertical magnetic recording head to record information on a vertical magnetic recording medium, which is a two-layer recording medium having a soft magnetic under layer (soft under layer: SUL) as a lower layer. Since the soft magnetic under layer is provided in the vertical magnetic recording medium, in the vertical recording method, the vertical magnetic recording head has a high recording performance, and can generate a recording magnetic field of 10 T (tesla) or more. Therefore, it is possible to record information on a recording layer of a vertical magnetic recording medium having a relatively strong coercive force of 5 kOe (kilo-oersted).

In this type of magnetic recording apparatus, with an increase in recording density, the magnitude of the magnetic field to be generated from the main magnetic pole is limited by an exciting coil, because the track width of the vertical magnetic recording medium is narrowed, or a magnetic material forming the main magnetic pole has limitations in saturation magnetic flux density, or any other reasons. In order to solve these problems, as shown in FIG. 10, a magnetic recording apparatus 200 has been proposed in which side shields 125 and 127 are provided at both sides of a leading end 123 of a main magnetic pole 121 in the track width direction, thereby preventing the magnetic field from leaking to tracks adjacent to a recording track, which is a recording target (for example, Patent JP-A-2005-190518 and Patent JP-A-2006-134540). In the magnetic recording apparatus 200, the distance between a vertical magnetic recording medium 101, which is a laminate of a soft magnetic under layer 102 and a recording layer 104, and the side shields 125 and 127 is equal to the distance between the vertical magnetic recording medium 101 and the leading end 123.

FIG. 11 is a graph illustrating the distribution of a recording magnetic field depending on the absence or presence of the side shields in the magnetic recording apparatus. In FIG. 11, the horizontal axis indicates a distance dw (nm) from the center of the recording track in the track width direction, and the vertical axis indicates a applied magnetic field Hw (kOe (kilo-oersted) applied. ‘Range A’ denotes the range of the recording track, and ‘Range B’ denotes the range of adjacent tracks. In addition, a track pitch is 80 nm. In the graph, a dashed line C2 indicates the distribution of the recording magnetic field of a magnetic recording apparatus without a side shield, and a solid line C3 indicates the distribution of the recording magnetic field of a magnetic recording apparatus with side shields. As can be seen from FIG. 11, in the magnetic recording apparatus with the side shields, the magnetic field leaking to adjacent tracks is more prevented than that in the magnetic recording apparatus without a side shield.

Further, a magnetic recording apparatus has been proposed in which, in order to prevent data from being erased due to a stray magnetic field, a soft magnetic shield is provided so as to surround a vertical magnetic recording head, and the distance between the soft magnetic shield and a medium is smaller than the distance between the soft magnetic shield and a vertical magnetic recording head (for example, see Patent JP-A-2006-164356).

However, the magnetic recording apparatus according to the related art shown in FIG. 10 has a structure in that the side shields are exposed from the surface facing a vertical magnetic recording medium. Therefore, a magnetic domain occurs due to, for example, the shape effect of the side shields, and the phenomenon so-called “erase” that erases the information recorded by magnetization on the tracks adjacent to the target recording track by the magnetic domain. The “erase” causes an S/N ratio (signal-to-noise ratio) to be lowered during the reproduction of the vertical magnetic recording medium, which makes it difficult to reproduce information recorded on the vertical magnetic recording medium. As a result, the recording performance of the magnetic recording apparatus according to the related art deteriorates, and the magnetic recording apparatus is impractical.

Further, in the magnetic recording apparatus according to the related art in which the distance between the soft magnetic shield and the medium is smaller than the distance between the soft magnetic shield and the vertical magnetic recording head such that the soft magnetic shield surrounds the vertical magnetic recording head, an object thereof is to prevent data from being erased due to the stray magnetic field. Therefore, it is difficult to increase the recording density of the magnetic recording apparatus and prevent a side erase.

FIG. 12 is a diagram illustrating magnetic field simulation results when the distance between the main magnetic pole and the soft magnetic shield varies as a parameter. In FIG. 12, the horizontal axis indicates the ratio d1/pt of a distance d1 between the main magnetic pole and the soft magnetic shield to a track pitch pt. In addition, the vertical axis indicates the ratio Hl/Hr of the strength Hl of a leakage magnetic field when a portion of the recording magnetic field leaks to adjacent tracks as a stray magnetic field to the strength Hr of the recording magnetic field applied to the recording track. The simulation results are obtained under the following conditions. The width of the leading end of the main magnetic pole on the trailing side in the track width direction is 50 nm (nanometers), the saturated magnetic flux density is 2.3 T (tesla), and a magnetomotive force of 0.20 AT (ampere-turn) is applied to a vertical magnetic recording medium. A dashed line C4 indicates the simulation results when the soft magnetic shield is not provided. As shown in FIG. 12, as the distance between the soft magnetic shield and the center of the recording track in the track width direction increases, that is, as the distance between the main magnetic pole and the soft magnetic shield increases, the ratio of the strength of the leakage magnetic field to the strength of the recording magnetic field increases. As represented by a dashed line C5 in the diagram, when the distance between the main magnetic pole and the soft magnetic shield is about 1.5 times larger than the track pitch in the track width direction, the ratio of the strength of the leakage magnetic field to the strength of the recording magnetic field is reduced to the same level as that in the magnetic recording apparatus without a soft magnetic shield. That is, in the magnetic recording apparatus in which the distance between the main magnetic pole and the soft magnetic shield is several tens of microns, it is difficult to prevent the side erase caused by the leakage magnetic field.

Furthermore, even though the magnetomotive force is increased to obtain a strong magnetic field, the magnitude of the recording magnetic field required to record information does not vary due to material limitations. As a result, only the magnitude of the leakage magnetic field increases, and it is difficult to improve the recording density of the magnetic recording apparatus.

### SUMMARY

According to an aspect of an embodiment, there is a vertical recording magnetic head that is mounted on a slider having a medium facing surface, including, a main magnetic pole that includes a leading end exposed from the medium facing surface, and side shields that are separated from the side surface of the leading end by a first distance and are retreated from the medium facing surface by a second distance.

### BRIEF DESCRIPTION OF THE DRAWINGS

FIG. 1 is a diagram schematically illustrating the internal structure of a hard disk driving apparatus provided with a vertical magnetic recording head according to a first embodiment;

FIG. 2 is a plan view illustrating a magnetic head element according to the first embodiment, as viewed from a magnetic disk 1;

FIG. 3 is a cross-sectional view taken along the line A-A′ of FIG. 2;

FIG. 4 is a cross-sectional view taken along the line B-B′ of FIG. 2;

FIG. 5 is a diagram schematically illustrating the operation of the magnetic head element according to the first embodiment to record information on the magnetic disk;

FIG. 6 is a cross-sectional view when the distance between a surface facing a medium and side shields according to the first embodiment varies;

FIG. 7 is an enlarged cross-sectional view illustrating neighborhood of a leading end of an induction-type recording magnetic head according to the first embodiment;

FIG. 8A is a diagram illustrating the simulation results when the distance between the surface facing a medium and the side shields according to the first embodiment is 0 nm;

FIG. 8B is a diagram illustrating the simulation results when the distance between the surface facing a medium and the side shields according to the first embodiment is 20 nm;

FIG. 8C is a diagram illustrating the simulation results when the distance between the surface facing a medium and the side shields according to the first embodiment is 40 nm;

FIG. 9 is a diagram illustrating the simulation results of variation in the strength of a leakage magnetic field when the distance between the surface facing a medium and the side shields according to the first embodiment varies;

FIG. 10 is a cross-sectional view illustrating a magnetic recording apparatus according to the related art;

FIG. 11 is a graph illustrating the distribution of a magnetic field depending on the absence or presence of side shields in the magnetic recording apparatus according to the related art; and

FIG. 12 is a diagram illustrating magnetic field simulation results when the distance between a main magnetic pole and a soft magnetic shield according to the related art varies as a parameter.

### DESCRIPTION OF THE PREFERRED EMBODIMENTS

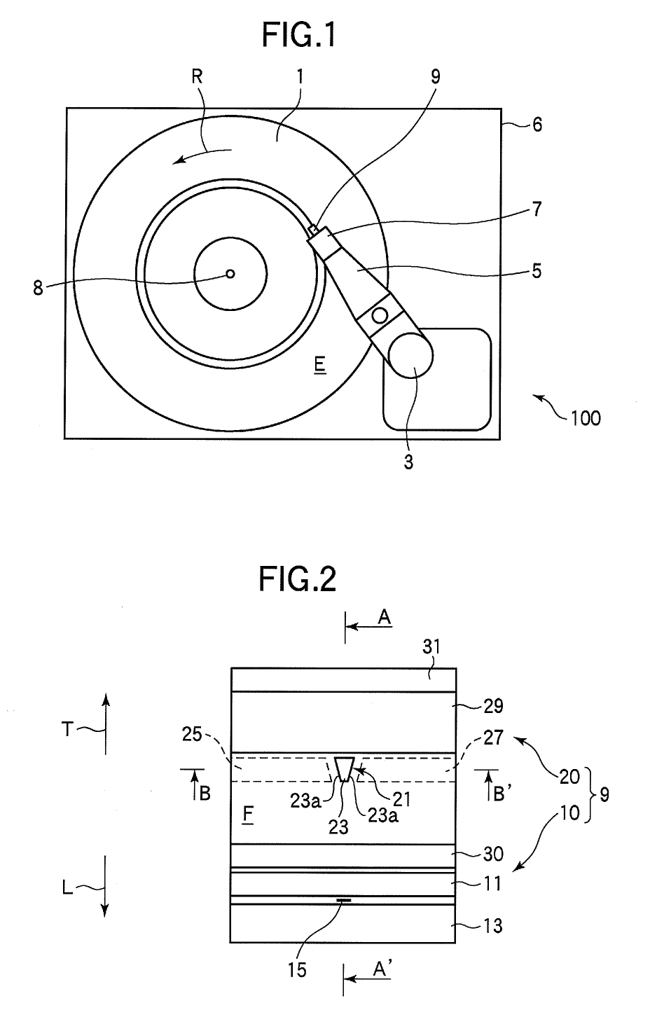

FIG. 1 is a diagram schematically illustrating the internal structure of a hard disk driving apparatus (magnetic recording apparatus) 100 provided with a magnetic head element (vertical magnetic recording head) 9 according to an embodiment. The magnetic recording apparatus 100 includes a box-shaped case 6 having, for example, a rectangular parallelepiped internal space. One or more magnetic disks (vertical magnetic recording media) 1 are accommodated in the accommodation space of the case 6.

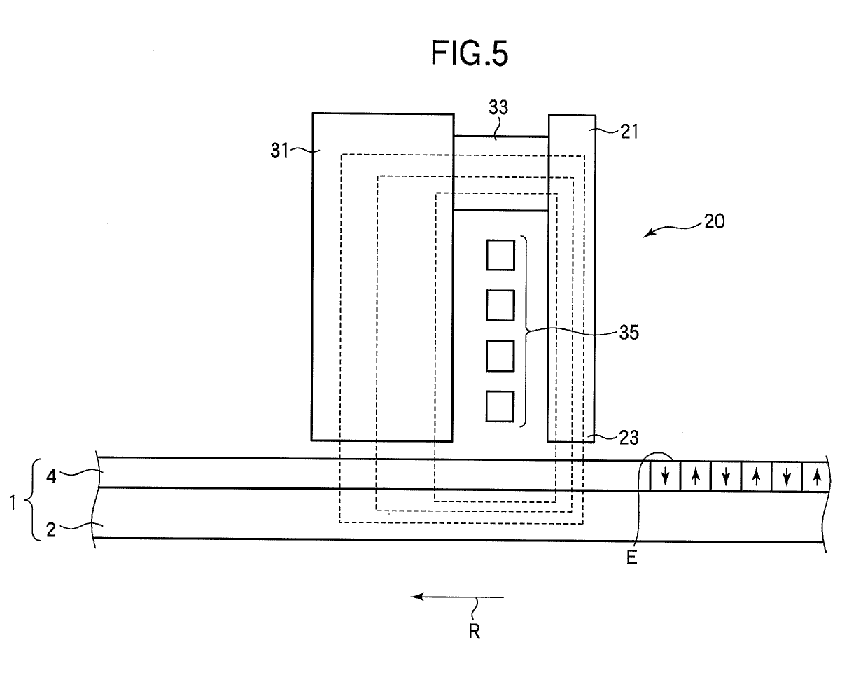

The magnetic disk 1 is formed by laminating a recording layer 4 (see FIG. 4) on a soft magnetic under layer 2 (see FIG. 4). The center of the magnetic disk 1 is fixed to a rotating shaft of a spindle motor 8.

The soft magnetic under layer 2 is formed of a soft magnetic material. The soft magnetic under layer 2 is a magnetic path through which a magnetic flux applied by the vertical magnetic recording head 9 passes, and returns the applied magnetic flux to the vertical magnetic recording head 9.

The recording layer 4 has a surface that serves as a recording surface E of the magnetic disk 1. The recording layer 4 is configured such that a coercive force in a direction that is vertical to the recording surface E is stronger than that in a direction parallel to the recording surface E. In this way, the recording layer 4 records information.

The spindle motor 8 can rotate the magnetic disk 1 in the direction that is represented by an arrow R in FIG. 1 at a high rotational speed of, for example, 4200 rpm (revolutions per minute) to 7200 rpm, or 15000 rpm. A cover (not shown) is coupled to the case 6 to seal the accommodation space of the case 6.

A suspension arm 5 operated by a rotary actuator 3, such as a voice coil motor (VCM), is provided in the accommodation space. A flying head slider 7 is supported by the leading end of the suspension arm 5 by a so-called gimbal spring (not shown). The flying head slider 7 is pressed against the recording surface E of the magnetic disk 1 by the suspension arm 5. Buoyancy acts on the flying head slider 7 due to air current generated from the recording surface E of the magnetic disk 1 when the magnetic disk 1 rotates. When the pressing force of the suspension arm 5 is balanced with the buoyancy, the flying head slider 7 can continuously float with relatively high stability while the magnetic disk 1 is being rotated.

When the suspension arm 5 is tilted while the flying head slider 7 floats, the flying head slider 7 can traverse the recording surface E of the magnetic disk 1 in the radial direction. The flying head slider 7 is positioned at a predetermined recording track on the magnetic disk 1 on the basis of this displacement. In this case, the suspension arm 5 is tilted by the rotary actuator 3. The flying head slider 7 is provided with the magnetic head element 9. The rotary actuator 3 rotates to move the magnetic head element 9 in another radial direction of the magnetic disk 1, thereby positioning the magnetic head element 9. A plurality of recording tracks are concentrically formed on the magnetic disk 1. The density of the magnetic disk 1 in a track width direction is improved by narrowing the track width of each recording track.

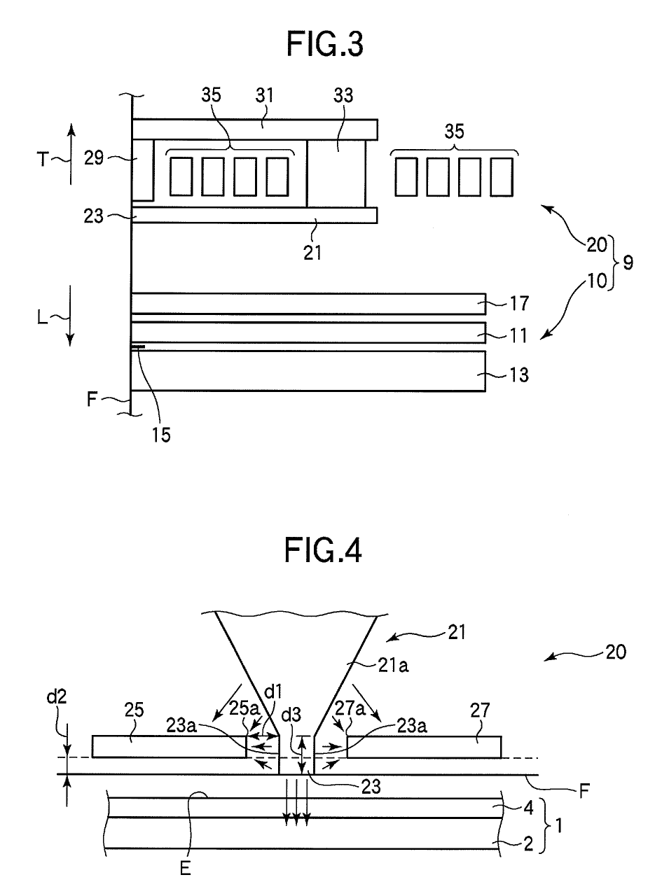

FIG. 2 is a plan view illustrating the magnetic head element 9, as viewed from the magnetic disk 1. FIG. 3 is a cross-sectional view taken along the line A-A′ of FIG. 2. FIG. 4 is a cross-sectional view taken along the line B-B′ of FIG. 2. In FIG. 4, an arrow schematically shows a magnetic flux.

As shown in FIG. 2, a surface of the magnetic head element 9 facing the magnetic disk 1 and a surface of the flying head slider 7 (see FIG. 1) facing the magnetic disk 1 form a medium facing surface F. The medium facing surface F is formed so as to face the recording surface E of the magnetic disk 1 (see FIG. 4).

The magnetic head element 9 includes a reproducing magnetic head 10 and an induction-type recording magnetic head 20. The reproducing magnetic head 10 is provided at the leading side of the magnetic head element 9 that is represented by an arrow L in the drawings. The reproducing magnetic head 10 includes a reproducing element 15 and a pair of magnetic shields 11 and 13.

The reproducing element 15 is formed of a magnetoresistive material, and is a magnetoresistive element (GMR) or a tunnel magnetoresistive element (TMR). The reproducing element 15 is provided between the pair of magnetic shields 11 and 13. A space between the reproducing element 15 and the magnetic shields 11 and 13 is filled up with a non-magnetic material. The electric resistance of the reproducing element 15 depends on the magnetic field applied to the magnetic disk 1. In this way, the information recorded on the magnetic disk 1 can be converted into electric signals, and read out from the magnetic disk 1.

The magnetic shields 11 and 13 are formed of a soft magnetic material, such as NiFe. The magnetic shields 11 and 13 absorb the magnetic field emitted from the magnetic disk 1 such that the reproducing element 15 can read out information in an exact range from the magnetic disk 1.

The induction-type recording magnetic head 20 is provided at the trailing side of the magnetic head element 9 that is represented by an arrow T in the drawings. The induction-type recording magnetic head 20 includes a main magnetic pole 21, a write shield 29, a coil 35 (see FIG. 3), a pair of return yokes 30 and 31, a magnetic core 33 (see FIG. 3), and a pair of side shields 25 and 27.

As shown in FIG. 3, the main magnetic pole 21 is formed so as to extend in a direction substantially vertical to the medium facing surface F. As shown in FIG. 4, the main magnetic pole 21 includes a tapered portion 21a that is tapered toward the medium facing surface F, as viewed from the leading side. The main magnetic pole 21 is formed by connecting a leading end 23 to the lower end of the tapered portion 21a. In this way, the leading end 23 and the tapered portion 21a are magnetically connected to each other. The leading end 23 has a constant width and extends up to the medium facing surface F. As shown in FIG. 2, the leading end 23 is exposed from the medium facing surface F such that it is visible from the magnetic disk 1 side. The leading end 23 is formed with gaps interposed between side surfaces 23a of the leading end 23 and the return yokes 30 and 31. The gaps between the leading end 23 and the return yokes 30 and 31 are filled up with a non-magnetic material.

The angle formed between the magnetic head element 9 and the recording track, that is, a yaw angle varies according to the position of the magnetic disk 1 in the radial direction. The yaw angle is in a range of, for example, ±15° to 20 at the maximum. In this way, in order to prevent a strong magnetic field from being applied to adjacent tracks, the leading end 23 exposed from the medium facing surface F is formed in a trapezoidal shape in which a side close to the leading side is smaller than another side close to the trailing side. That is, as shown in FIG. 2, the main magnetic pole 21 has an inverted trapezoidal shape with the leading side facing downward. The main magnetic pole 21 generates a recording magnetic field and records information on the magnetic disk 1.

As shown in FIG. 3, the write shield 29 is a magnetic body that protrudes from the return yoke 31 to the main magnetic pole 21. That is, the write shield 29 is provided at the trailing side of the main magnetic pole 21. The write shield 29 absorbs a portion of the recording magnetic field emitted from the main magnetic pole 21 to adjust the range of the magnetic field applied to the magnetic disk 1.

The pair of return yokes 30 and 31 are auxiliary magnetic poles. The return yokes 30 and 31 are formed so as to interpose the main magnetic pole 21, the write shield 29, the coil 35, the magnetic core 33, and the pair of side shields 25 and 27 therebetween. The gap between the return yoke 30 and the magnetic shield 11 is filled up with a non-magnetic material.

As shown in FIG. 3, the coil 35 is wound around the magnetic core 33. The coil 35 is supplied with electric power to excite the magnetic core 33.

The magnetic core 33 is provided between the main magnetic pole 21 and the return yoke 31 while coming into contact with the main magnetic pole 21 and the return yoke 31. The magnetic core 33 is excited by the coil 35 to generate the recording magnetic field in the main magnetic pole 21.

As shown in FIG. 4, the pair of side shields 25 and 27 are plate members that are formed along the medium facing surface F. The side shields 25 and 27 are formed of a magnetic material including at least one of Fe, Ni, and Co. The pair of side shields 25 and 27 are provided at both sides of the side surface 23a, with the leading end 23 of the main magnetic pole 21 interposed therebetween. The side surface 23a of the leading end 23 and the side shield 25 or 27 are arranged with distance (first distance) d1 between along the medium facing surface F. The gaps between the side surface 23a and the side shields 25 and 27 are filled up with a non-magnetic material. The pair of side shields 25 and 27 are arranged in the track width direction of the recording track when information is recorded on the magnetic disk 1.

The side shields 25 and 27 are provided so as to be retreated from the medium facing surface F to the inside of the magnetic head element 9 by a distance (second distance) d2. The gaps between the medium facing surface F and the side shields 25 and 27 are also filled up with a non-magnetic material. The distance d2 between the side shields 25 and 27 and the medium facing surface F is smaller than a distance d3 between the medium facing surface F and a connection point between the leading end 23 and the tapered portion 21a.

FIG. 5 is a diagram schematically illustrating the operation of the magnetic head element 9 recording information on the magnetic disk 1.

When the magnetic head element 9 records information on the magnetic disk 1, a current flows to the coil 35 of the induction-type recording magnetic head 20 to excite the magnetic core 33. Then, a magnetic field is generated in a direction vertical to the recording surface E of the magnetic disk 1 between the leading end 23 of the main magnetic pole 21 and the soft magnetic under layer 2, which causes information to be recorded on the recording layer 4 of the magnetic disk 1.

The magnetic flux flowing to the soft magnetic under layer 2 through the recording layer 4 returns to the return yoke 31 of the induction-type recording magnetic head 20. As such, a magnetic circuit is formed by the coil 35, the magnetic core 33, the main magnetic pole 21, the magnetic disk 1, and the return yoke 31.

When information is recorded on the recording layer 4, the magnetization state of the recording layer 4 depends on the shape of the leading end 23 of the main magnetic pole 21 facing the recording surface E. In particular, a stronger magnetic field is applied to record information at a downstream side in the direction in which the recording layer 4 is moved relative to the induction-type recording magnetic head 20, that is, at the trailing side that is widely formed in the track width direction, when the magnetic disk 1 is rotated.

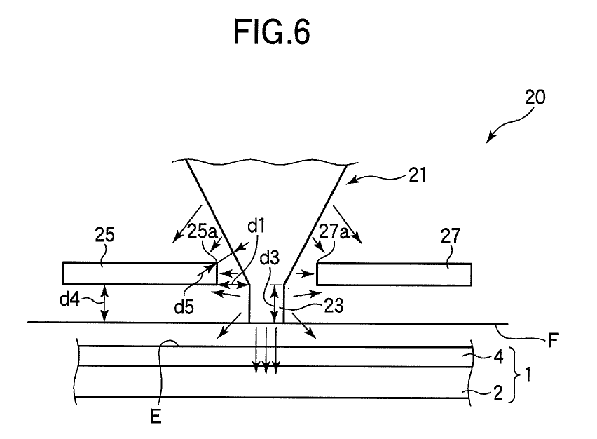

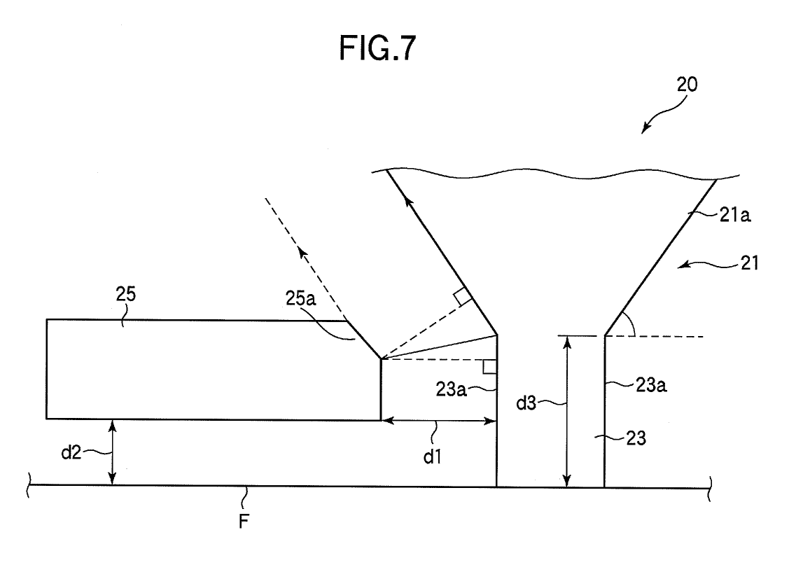

FIG. 6 is a cross-sectional view when the distance between the side shields 25 and 27 and the medium facing surface F varies. FIG. 7 is an enlarged cross-sectional view illustrating the leading end 23 of the induction-type recording magnetic head 20.

It is preferable that the side shields 25 and 27 be separated from the tapered portion 21a of the main magnetic pole 21 by a distance that is substantially equal to the track pitch of the magnetic disk 1. In this way, the side shields 25 and 27 can prevent a leakage magnetic field from being applied to adjacent tracks while preventing a reduction in the magnetic field required for the induction-type recording magnetic head 20 to record information on the magnetic disk 1.

When a distance between the side shields 25 and 27 and the medium facing surface F is distance d4 which is longer than the distance d2, as shown in FIG. 6, a distance d5 between the tapered portion 21a and edges 25a and 27a of the side shields 25 and 27 formed in the tapered portion 21a side is shorter than the distance d1. In this case, the magnetic flux from the main magnetic pole 21 flows to the side shields 25 and 27, which results in a reduction in the strength of the recording magnetic field. However, in this embodiment, as shown in FIG. 7, the edges 25a and 27a of the side shields 25 and 27 are formed to have shapes corresponding to the inclined plane of the tapered portion 21a, or they are formed in shapes in which, as the distance from the medium facing surface F increases, the distance between the side shields 25 and 27 and the main magnetic pole 21 increases. In addition, the distance d5 between the edges 25a and 27a and the tapered portion 21a is equal to or larger than the distance d1 between the side surface 23a and the side shields 25 and 27. In this way, the side shields 25 and 27 provided in the induction-type recording magnetic head 20 make it possible to minimize reduction in the strength of the recording magnetic field.

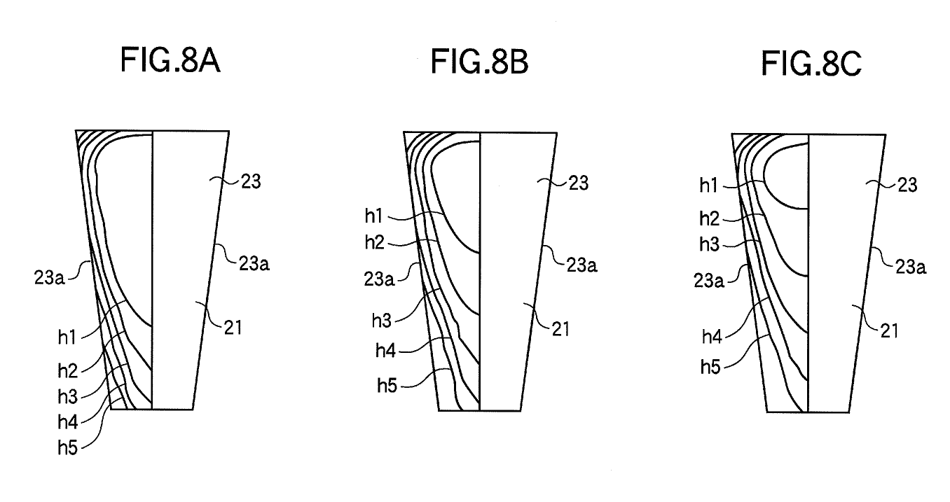

FIGS. 8A to 8C are diagrams illustrating simulation results of the distribution of the magnetic field in the leading end 23 when the distance d2 between the side shields 25 and 27 and the medium facing surface F varies. FIGS. 8A to 8C are diagrams illustrating the leading end 23, as viewed from the magnetic disk 1 side, and show the simulation results of only half the leading end 23. Lines h1 to h5 show boundary lines connecting points where the magnitudes of the magnetic field are equal to each other. Among the lines h1 to h5, the line h1 has the largest magnetic field value, followed by the line h2, the line h3, the line h4, and the line h5.

FIG. 8A shows the simulation results when the distance d2 between the side shields 25 and 27 and the medium facing surface F is 0 (zero) nm. As shown in FIG. 8A, the distribution of the magnetic field in the leading end 23 is spread in the track width direction and the bit length direction.

FIG. 8B shows the simulation results when the distance d2 between the side shields 25 and 27 and the medium facing surface F is 20 nm. As shown in FIG. 8B, the distribution of the magnetic field in the leading end 23 is narrower than that when the distance d2 is 0 (zero) nm in the track width direction and the bit length direction.

FIG. 8C shows the simulation results when the distance d2 between the side shields 25 and 27 and the medium facing surface F is 40 nm. As shown in FIG. 8C, the distribution of the magnetic field in the leading end 23 is narrower than that when the distance d2 is 20 nm in the bit length direction. As represented by the line h1, the region in which the magnetic field is the strongest is concentrated on the trailing side end of the leading end 23 of the main magnetic pole 21. That is, the side shields 25 and 27 absorb an unnecessary magnetic flux emitted to the outside when magnetic flux saturation occurs in the edge of the leading end 23 on the leading side of the main magnetic pole. Therefore, it is expected to prevent a side erase when considering a yaw angle.

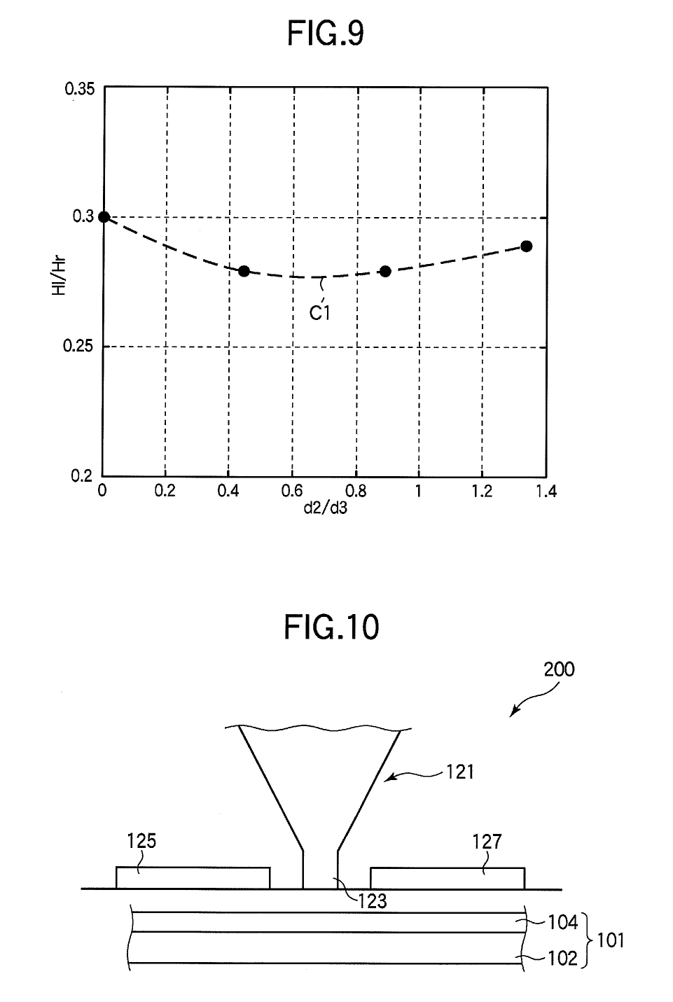

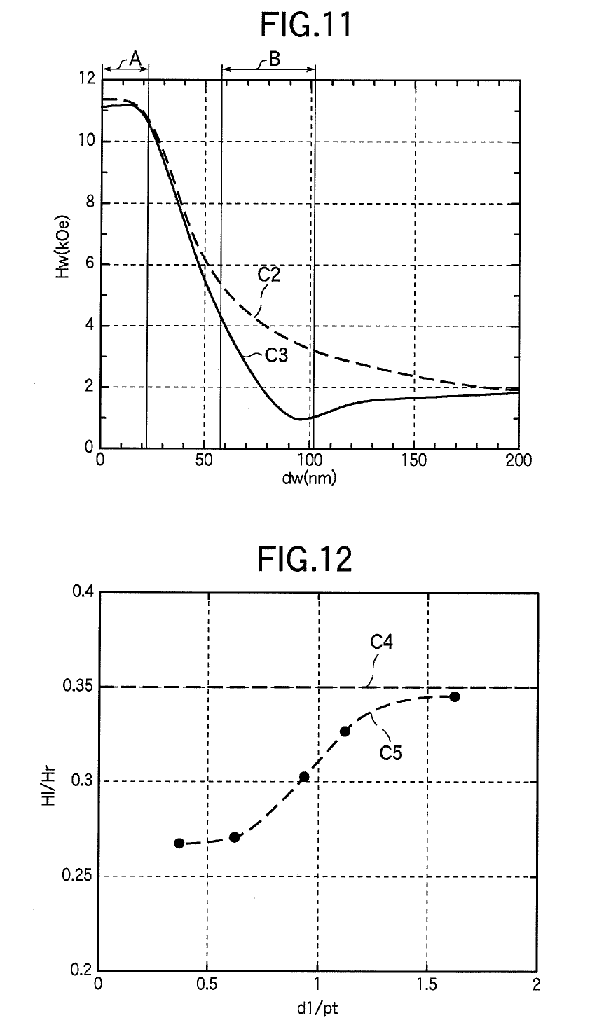

FIG. 9 is a diagram illustrating simulation results of variation in the strength of a leakage magnetic field when the distance d2 between the side shields 25 and 27 and the medium facing surface F varies. The simulation results are obtained under the following conditions. The width of the leading end of the main magnetic pole on the trailing side in the track width direction is 50 nm (nanometers), the saturated magnetic flux density is 2.3 T (tesla), and a magnetomotive force of 0.20 AT (ampere-turn) is applied to a vertical magnetic recording medium. In addition, the distance d3 between the medium facing surface F and the connection point between the leading end 23 and the tapered portion 21a is 100 nm. In FIG. 9, the horizontal axis indicates the ratio d2/d3 of the distance d2 between the side shields 25 and 27 and the medium facing surface F to the distance d3, and the vertical axis indicates the ratio Hl/Hr of the strength Hl of the leakage magnetic field when a portion of the recording magnetic field leaks to adjacent tracks to the strength Hr of the recording magnetic field applied to the recording track.

In FIG. 9, as represented by a line C1, the ratio Hl/Hr of the strength Hl of the leakage magnetic field when a portion of the recording magnetic field leaks to adjacent tracks to the strength Hr of the recording magnetic field applied to the recording track is the smallest at the position where the ratio d2/d3 is about 0.7. In this way, when the ratio d2/d3 is about 0.7, it is possible to improve the density of the magnetic disk 1 in the track width direction, as compared to when the ratio d2/d3 is 0 (zero) in which the distance d2 is 0 (zero) nm. As a result, it is possible to improve recording density.

As described above, according to the above-described embodiment, the vertical magnetic recording head 9 includes the side shields 25 and 27 that are separated from the side surface 23a of the leading end 23 of the main magnetic pole 21 by the distance d1 along the medium facing surface F and are retreated from the medium facing surface F to the inside of the magnetic head element 9 by the distance d2. In this way, the vertical magnetic recording head 9 absorbs an unnecessary magnetic flux emitted to the outside when magnetic flux saturation occurs in the leading end 23. Therefore, the vertical magnetic recording head 9 can prevent the leakage of magnetic flux without deteriorating a recording performance.

Although the embodiment has been described above, the invention is not limited thereto, but various modifications and changes can be made.

In the above-described embodiment, the side shields 25 and 27 are formed of plate members that extend along the medium facing surface F, but the invention is not limited thereto. For example, the planer figure of the side shields may be formed such that the width, in the direction which the side shields become distant from the medium facing surface side, at the end close to the main magnetic pole is wider than the end at opposite side of the main magnetic pole. In this way, the side shields are formed to have the end at distant side from the main magnetic pole more distant from the medium facing surface than the end close to the main magnetic pole. Therefore, it is possible to prevent the problem of the magnetic flux being applied from the other end of the side shield opposite to the main magnetic pole to the magnetic disk 1. As a result, it is possible to obtain the same effect as described above from the structure in which a side shield and a write shield are connected to each other.

In the above-described embodiment, one coil 35 is wound around the magnetic core 33, but the invention is not limited thereto. For example, an auxiliary coil that has substantially the same shape as the coil 35 may be provided on the opposite side of the coil 35 against the main magnetic pole 21. In this way, it is possible to prevent the erase of information recorded on the magnetic disk 1, which is the unique problem of the vertical magnetic recording head 9.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A vertical recording magnetic head that is mounted on a slider having a medium facing surface, comprising:
a main magnetic pole that includes a leading end exposed from the medium facing surface; and
side shields that are separated from the side surface of the leading end by a first distance and are retreated from the medium facing surface by a second distance.

2. The vertical recording magnetic head according to claim 1,
wherein a non-magnetic material is provided between the leading end and the side shields and between the medium facing surface and the side shields.

3. The vertical recording magnetic head according to claim 2,
wherein the side shields are provided at both sides of the side surface of the leading end.

4. The vertical recording magnetic head according to claim 3, further comprising:
a tapered portion that is magnetically connected to the leading end,
wherein the second distance is smaller than the distance from the medium facing surface to a connection point between the leading end and the tapered portion.

5. The vertical recording magnetic head according to claim 4,
wherein the distance between the tapered portion and the side shields is equal to or lager than the first distance.

6. The vertical recording magnetic head according to claim 5,
wherein the surface of the main magnetic pole facing a medium has an inverted trapezoidal shape.

7. The vertical recording magnetic head according to claim 6,
wherein the planer figure of the side shield is formed such that the width, in the direction which the side shield become distant from the medium facing surface side, at the end close to the main magnetic pole is wider than the end at opposite side of the main magnetic pole.

8. The vertical recording magnetic head according to claim 7,
wherein the side shields are formed of a magnetic material including at least one of Fe, Ni, and Co.

9. A magnetic recording apparatus comprising:
a vertical recording magnetic head that is mounted on a slider having a medium facing surface,
wherein the vertical recording magnetic head has a main magnetic pole that includes a leading end exposed from the medium facing surface and side shields that are separated from the side surface of the leading end by a first distance and are retreated from the medium facing surface by a second distance.
